(19) United States
(12) Patent Application Publication
(10) Pub. No.: US 2026/0233041 A1
(43) Pub. Date: Aug. 13, 2026

(54) SPRINKLER HEAD BRACKET

(71) Applicant: Young Soon LIM, Hwaseong-si (KR)

(72) Inventor: Young Soon LIM, Hwaseong-si (KR)

(21) Appl. No.: 19/151,302

(22) PCT Filed: Aug. 14, 2023
(86) PCT No.: PCT/KR2023/012053

§ 371 Date: Jul. 25, 2025

(30) Foreign Application Priority Data
Jan. 27, 2023 (KR) 10-2023-0010680

(51) Int. Cl. A62C 35/68

(52) U.S. Cl. CPC A62C 35/68

(57) ABSTRACT

Provided is a sprinkler head bracket including a first fastening member disposed so as to wrap around a sprinkler head, the first fastening member including a first through-hole, a fixing member configured to extend through the first through-hole of the first fastening member, and a second fastening member including a fixture configured to allow at least a part of the fixing member that has extended through the first through-hole to be inserted thereinto, the second fastening member being disposed so as to wrap around the sprinkler head together with the first fastening member as the fixing member is inserted into the fixture.

### BACKGROUND OF THE INVENTION

### Field of the Invention

The present invention relates to a sprinkler head bracket.

### Description of the Related Art

A sprinkler is a device that sprays water. In particular, the sprinkler is mounted on the ceiling of a building and performs a very important function in suppressing fire in an early stage by spraying water when fire breaks out. The sprinkler includes a sprinkler head that sprays water and a pipe connected to the sprinkler head to supply water to the sprinkler head, wherein the sprinkler head is fixed to a beam disposed on the ceiling of a building. In this case, a device for fixing the sprinkler head to the beam is a sprinkler head bracket.

In a conventional sprinkler head bracket, it is difficult to reset the position of the sprinkler head bracket once the sprinkler head bracket is fixed. In addition, the sprinkler head bracket must be supported using one hand such that the sprinkler head bracket is located at a designated position, and a fixing process is performed using the other hand, which is inconvenient and may cause a safety incident. Furthermore, since the fixing process is performed in a lateral direction of the sprinkler head bracket, it is difficult to secure sufficient working space.

Korean Registered Patent No. 10-1335984, which is the prior art document, discloses a conventional sprinkler head bracket (sprinkler head fixing device). For the sprinkler head bracket disclosed herein, an operator fixes the sprinkler head bracket to a sprinkler body using one hand and then presses a handle using the other hand to fix the same.

### Prior Art Documents

### Patent Documents

(Patent Document 1) Korean Registered Patent No. 10-1335984

### SUMMARY OF THE INVENTION

It is an object of the present invention to provide a sprinkler head bracket capable of increasing the convenience of a sprinkler head fastening operation.

It is another object of the present invention to provide a sprinkler head bracket capable of increasing work speed and improving work accuracy.

In accordance with the present invention, the above and other objects can be accomplished by the provision of a sprinkler head bracket including a first fastening member disposed so as to wrap around a sprinkler head, the first fastening member including a first through-hole, a fixing member configured to extend through the first through-hole of the first fastening member, and a second fastening member including a fixture configured to allow at least a part of the fixing member that has extended through the first through-hole to be inserted thereinto, the second fastening member being disposed so as to wrap around the sprinkler head together with the first fastening member as the fixing member is inserted into the fixture.

The fixture may be formed in a shape having a width gradually decreasing in a first direction when viewed in a direction in which the fixing member is inserted into the fixture.

The first direction may be a direction perpendicular to the direction in which the fixing member is inserted into the fixture.

The sectional shape of at least a part of an inner side of the fixture may gradually decrease in width in a second direction.

The second direction may be a direction in which the fixing member is inserted into the fixture.

The fixing member may include a head, a screw thread portion connected to the head, the screw thread portion including a screw thread, and a tapered portion connected to the screw thread portion, the tapered portion having a shape inclined such that the width of the section of the tapered portion is reduced.

The first through-hole may include a screw thread corresponding to the screw thread of the fixing member.

The tapered portion may come into contact with the fixture as the fixing member is inserted into the fixture, whereby the fixing member may inserted into the fixture while moving in the first direction.

The tapered portion may come into contact with an inclined side of the fixture as the fixing member is inserted into the fixture, whereby the fixing member may inserted into the fixture while moving in the first direction.

The sprinkler head bracket may further include a hinge member configured to allow the first fastening member and the second fastening member to rotate relative to each other thereabout.

The sprinkler head bracket according to the embodiment of the present invention is capable of increasing the convenience of the sprinkler head fastening operation.

In addition, the sprinkler head bracket according to the embodiment of the present invention is capable of increasing work speed and improving work accuracy.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a sprinkler head bracket according to an embodiment of the present invention when viewed from above;

FIG. 2 is a perspective view of the sprinkler head bracket shown in FIG. 1 when viewed from below;

FIG. 3 is an exploded perspective view of the sprinkler head bracket shown in FIG. 1;

FIGS. 4 to 6 show a process of fastening the sprinkler head bracket when viewed from above (a) and when viewed from below (b);

FIG. 7 shows the movement relationship between a fixing member and a fixture when the sprinkler head bracket is fastened;

FIG. 8 is a perspective view of a sprinkler head bracket according to another embodiment of the present invention; and

FIG. 9 shows that the sprinkler head bracket is fastened to a sprinkler head.

### DETAILED DESCRIPTION OF THE INVENTION

Hereinafter, preferred embodiments of the present invention will be described with reference to the accompanying drawings. However, the embodiments of the present invention may be modified in various other forms, and the scope of the present invention is not limited to the embodiments described below. In addition, the embodiments of the present invention are provided to more fully describe the present invention to those skilled in the art. Therefore, the shapes and sizes of elements in the drawings may be exaggerated for clarity, and elements denoted by the same reference numerals in the drawings are identical elements. In addition, the same reference numerals are used for parts that perform similar functions and operations throughout the drawings. Furthermore, unless otherwise specified, the term “include” in the entire specification means that other components may be included, not that other components are excluded.

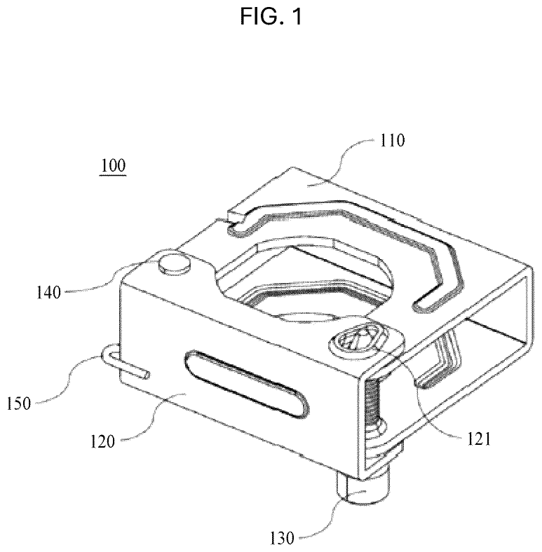

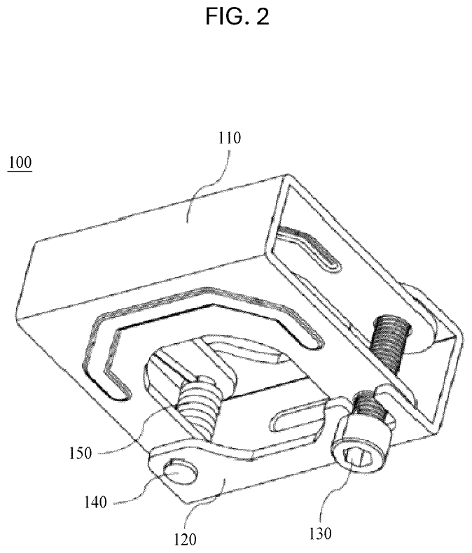

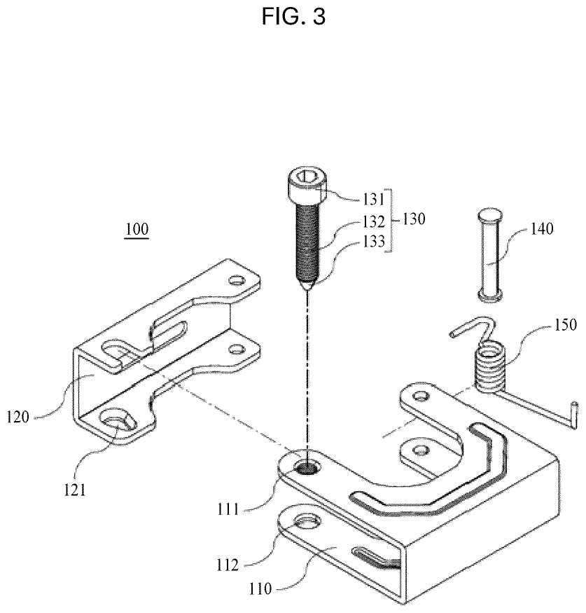

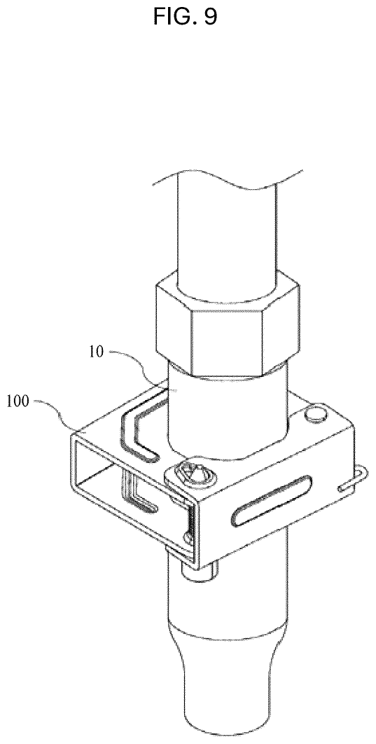

FIG. 1 is a perspective view of a sprinkler head bracket 100 according to an embodiment of the present invention when viewed from above, FIG. 2 is a perspective view of the sprinkler head bracket 100 shown in FIG. 1 when viewed from below, and FIG. 3 is an exploded perspective view of the sprinkler head bracket 100 shown in FIG. 1. FIG. 9 shows that the sprinkler head bracket 100 is fastened to a sprinkler head 10.

*

Referring to FIGS. 1 to 3, the sprinkler head bracket 100 according to the embodiment of the present invention includes a first fastening member 110 disposed so as to wrap around a sprinkler head 10, the first fastening member 110 including a first through-hole 111, a fixing member 130 configured to extend through the first through-hole 111 of the first fastening member 110, and a second fastening member 120 including a fixture 121 configured to allow at least a part of the fixing member 130 that has extended through the first through-hole 111 to be inserted thereinto, the second fastening member 120 being disposed so as to wrap around the sprinkler head 10 together with the first fastening member 110 as the fixing member 130 is inserted into the fixture 121.

The first fastening member 110 and the second fastening member 120 perform the function of wrapping around the sprinkler head 10 (see FIG. 9). To this end, each of the first fastening member 110 and the second fastening member 120 may have a bent shape or a recess corresponding to the shape of an outer circumferential surface of the sprinkler head 10.

Referring to FIG. 1, each of the first fastening member 110 and the second fastening member 120 may be formed in a ‘[’ shape when viewed from above. Referring to FIG. 3, each of the first fastening member 110 and the second fastening member 120 may include two plates disposed spaced apart from each other so as to face each other and an extension plate disposed between the two plates. Consequently, each of the first fastening member 110 and the second fastening member 120 has a ‘[’ shape.

The first fastening member 110 and the second fastening member 120 may be fastened to the outer circumferential surface of the sprinkler head 10 by rotating about a single axis so as to be closed or may be detached from the sprinkler head 10 by rotating about the single axis so as to be open. To this end, the first fastening member 110 and the second fastening member 120 may rotate relative to each other about a hinge member 140. The hinge member 140 may be a pin, and each of the first fastening member 110 and the second connecting member may include at least one hole configured to allow the hinge member 140 to be inserted thereinto.

Referring to FIGS. 1 to 3, a hole into which the hinge member 140 is inserted is provided in one end of each of the two plates of each of the first fastening member 110 and the second fastening member 120, and one end of the first fastening member 110 and one end of the second fastening member 120 are disposed so as to overlap each other, whereby the first fastening member 110 and the second fastening member 120 may rotate around the hinge member 140.

The first fastening member 110 and the second fastening member 120 may further include a spring member 150 configured to maintain the state in which the first fastening member 110 and the second fastening member 120 are closed if external force is not applied thereto. The spring member 150 may apply force to the first fastening member 110 and the second fastening member 120 such that the first fastening member 110 and the second fastening member 120 are closed. To this end, the spring member 150 may include a coil spring. A coil portion of the coil spring may be disposed to wrap around the hinge member 140, wherein one end of the coil portion may be fixed to the first fastening member 110 and the other end of the coil portion may be fixed to the second fastening member 120.

Each of the first fastening member 110 and the second fastening member 120 includes holes into which the fixing member 130 is inserted. The first fastening member 110 includes a first through-hole 111 formed in one end thereof to allow the fixing member 130 to extend therethrough. In addition, the second fastening member 120 includes a fixture 121 into which at least a part of the fixing member 130 is inserted. When the first fastening member 110 and the second fastening member 120 are in a closed state, the first through-hole 111 and the fixture 121 may be disposed so as to overlap each other.

Referring to FIG. 3, a hole configured to allow the fixing member 130 to be inserted thereinto is formed in the other end of each of the two plates of the first fastening member 110. In FIG. 3, the hole formed in the plate into which the fixing member 130 is inserted first is the first through-hole 111, and the hole formed in the plate into which the fixing member 130 is inserted later is a second through-hole 112. In addition, one of the two plates of the second fastening member 120 that is disposed so as to overlap the first through-hole 111 of the first fastening member 110 has a recess formed in a shape that wraps around the fixing member 130 from the side, and the other plate has a fixture 121 into which the fixing member 130 is inserted. This allows an operator to fix the second fastening member 120 to the sprinkler head 10 by fastening the second fastening member 120 in the state in which the fixing member 130 is partially inserted into the first fastening member 110, thereby improving work convenience.

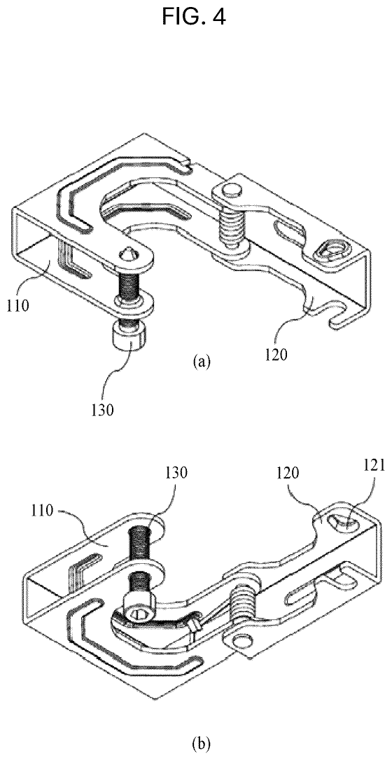

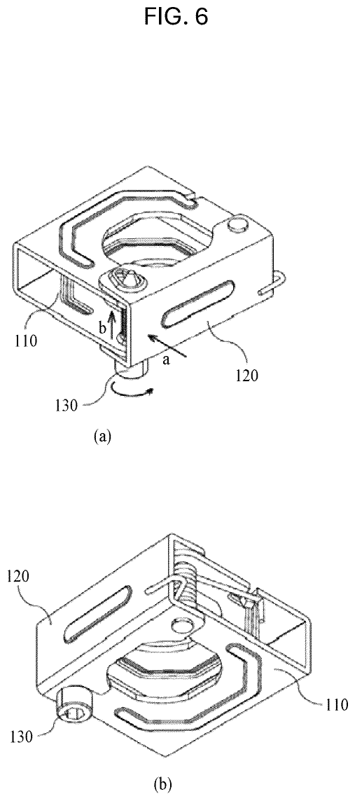

Referring to FIGS. 4 to 6, a hole configured to allow the hinge member 140 to be inserted thereinto is formed in one end of each of the two plates of the first fastening member 110 and the second fastening member 120, and the other end of the first fastening member 110 and the other end of the second fastening member 120 are disposed so as to overlap each other in the state in which the first fastening member 110 and the second fastening member 120 are closed. As the other end of the first fastening member 110 and the other end of the second fastening member 120 are disposed so as to overlap each other, as described above, the first fastening member 110 and the second fastening member 120 may be fixed by the fixing member 130.

The fixing member 130 is inserted into the holes and recesses of the first fastening member 110 and the second fastening member 120, as described above, to enable the first fastening member 110 and the second fastening member 120 to tighten the sprinkler head 10. The fixing member 130 may be formed in the shape of a bolt having a screw thread.

More specifically, the fixing member 130 may include a head, a screw thread portion 132 connected to the head, the screw thread portion 132 including a screw thread, and a tapered portion 133 connected to the screw thread portion 132, the tapered portion 133 having a shape inclined such that the width of the section of the tapered portion 133 is reduced. The head enables the operator to apply force to the fixing member 130 such that the fixing member 130 can be operated, and the screw thread portion 132 enables the fixing member 130 to move along a screw thread formed on an inner circumferential surface of the first through-hole 111 and to be fixed thereto. The tapered portion 133 widens the area where the fixing member 130 is in contact with an inner circumferential surface of the fixture 121 to increase the force that the fixing member 130 applies to the second fastening member 120, thereby facilitating movement of the fixing member 130.

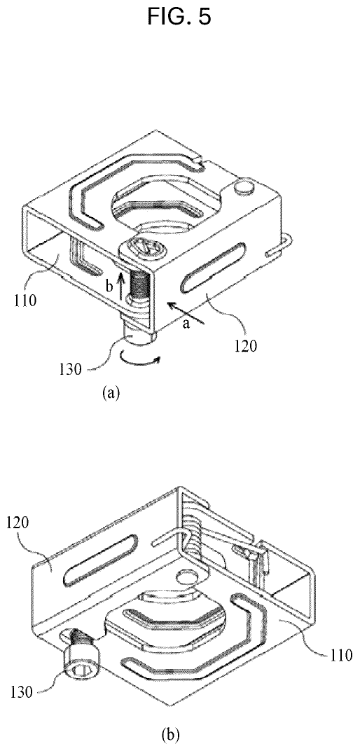

The tapered portion 133 has a shape inclined such that the width of the section of the tapered portion 133 is reduced, and may have a triangular cone shape, as shown in FIG. 3. Referring to FIGS. 4 to 6, the fixing member 130 may be inserted into the fixture 121 of the second fastening member 120 through the first through-hole 111 and the second through-hole 112 of the first fastening member 110, and force may be applied to the inner circumferential surface of the fixture 121 such that the second fastening member 120 moves in a direction (a) perpendicular to an insertion direction (b). Referring to FIGS. 5 to 7, it can be seen that, as the fixing member 130 is inserted in the direction (b), the second fastening member 120 moves in the direction (a).

A screw thread corresponding to the screw thread of the screw thread portion 132 of the fixing member 130 may be formed on the inner circumferential surface of the first through-hole 111 of the first fastening member 110. An inner circumferential surface of the second through-hole 112 may not have a screw thread. This allows the fixing member 130 to be easily inserted into the fixture 121 through the second through-hole 112 and to be fixed in position by appropriate force.

The fixture 121 of the second fastening member 120 is pressed by the fixing member 130 as the fixing member 130 is inserted into the fixture 121, causing the second fastening member 120 to move in a direction in which the second fastening member 120 presses the first fastening member 110, thereby enabling the first fastening member 110 and the second fastening member 120 to strongly fix the sprinkler head. To this end, the fixture 121 may be a hole formed through the second fastening member 120 or a recess formed so as to be depressed inward from the side of the second fastening member 120. Preferably, the fixture 121 of the second fastening member 120 may be formed in a shape having a width gradually decreasing in a first direction when viewed in a direction in which the fixing member 130 is inserted into the fixture 121. The first direction may be a direction perpendicular to the direction in which the fixing member 130 is inserted into the fixture 121.

Referring to FIG. 3, the fixture 121 may be triangular or teardrop-shaped. In other embodiments, the fixture 121 may be quadrangular, diamond-shaped, circular, elliptical, or polygonal. In addition, the fixture 121 may be a recess which is formed through the second fastening member 120 and a part of the inner circumferential surface of which is open to the side, in which case the recess may have a curved shape or a polygonal shape. Referring to FIG. 8, the fixture 121 is a recess, and it can be seen that the fixture 121 is tapered such that the width of the fixture 121 gradually decreases in the direction in which the fixing member 130 is inserted.

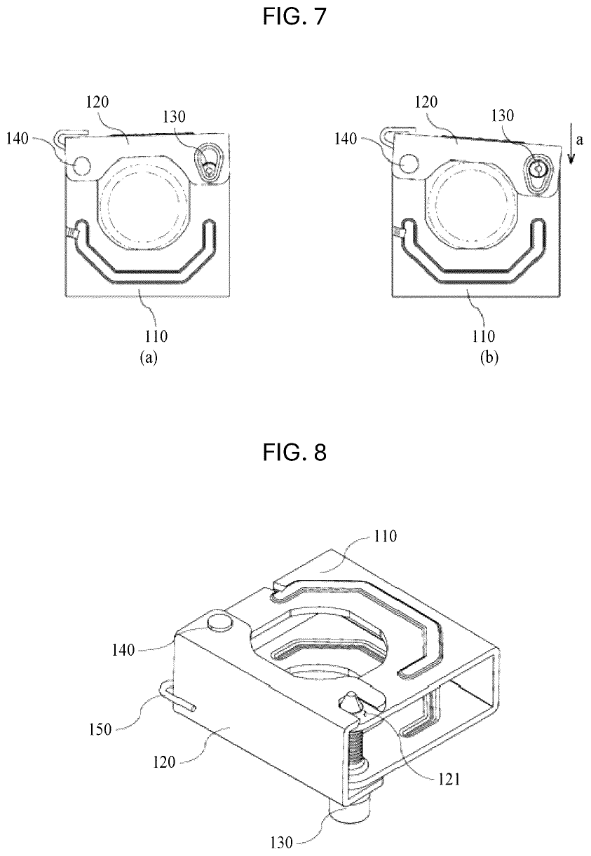

Referring to FIGS. 5 to 7, at the initial stage when the fixing member 130 is inserted into the fixture 121, a pointed portion of the fixing member 130 may be inserted into a narrow width portion of the fixture 121 (FIG. 7(a)). Subsequently, as the fixing member 130 is further inserted into the fixture 121 in the direction (b), the sectional area of the part of the fixing member 130 that comes into contact with the inner circumferential surface of the fixing member 121 increases, causing the fixing member 121 to move in the direction (a) (FIG. 7(b)). As a result, the first fastening member 110 and the second fastening member 120 strongly clamp the sprinkler head 10 located therebetween, whereby the fixing force is increased. In addition, the operator may fix the sprinkler head 10 simply by manipulating the fixing member 130 under the sprinkler head 10 using a tool such as a screwdriver, making the work simple and efficient.

In addition, the sectional shape of at least a part of an inner side of the fixture 121 may gradually decrease in width in a second direction. The second direction may be a direction in which the fixing member 130 is inserted into the fixture 121.

More specifically, the inner circumferential surface of the fixture 121 may be tapered such that the sectional area of the inner circumferential surface of the fixture 121 gradually decreases in the direction in which the fixing member 130 is inserted into the fixture 121. FIG. 4(b) shows a tapered fixture 121.

As described above, the fixing member 130 may include a tapered portion 133 having an inclined shape at one end thereof. The contact area may be maximized by bringing an outer circumferential surface of the tapered portion 133 of the fixing member 130 and the inclined inner circumferential surface of the fixture 121 into contact with each other. As a result, the transmission of force causing the second fastening member 120 to move in the direction (a) by the fixing member 130 may be efficient. In addition, even when the fixing member 130 is completely inserted, the area at which the fixing member 130 and the fixture 121 are in contact with each other is large, and therefore the fixing member 130 may be prevented from moving out of position.

*

The present invention is not limited to the above-described embodiments and the accompanying drawings, but is intended to be limited by the appended claims. Therefore, various substitutions, modifications, and changes may be made by those skilled in the art within the technical concept of the present invention as described in the appended claims, and these are also considered to be within the scope of the present invention.

What is claimed is:

1. A sprinkler head bracket comprising:
a first fastening member disposed so as to wrap around a sprinkler head, the first fastening member comprising a first through-hole;
a fixing member configured to extend through the first through-hole of the first fastening member; and
a second fastening member comprising a fixture configured to allow at least a part of the fixing member that has extended through the first through-hole to be inserted thereinto, the second fastening member being disposed so as to wrap around the sprinkler head together with the first fastening member as the fixing member is inserted into the fixture, wherein
the fixture is formed in a shape having a width gradually decreasing in a first direction when viewed in a direction in which the fixing member is inserted into the fixture, and
the fixing member comprises a tapered portion having a shape inclined such that a width of a section of the tapered portion is reduced, the tapered portion coming into contact with the fixture as the fixing member is inserted into the fixture, whereby the fixing member is inserted into the fixture while moving in the first direction.

2. The sprinkler head bracket according to claim 1, wherein the fixture is formed in a shape having a width gradually decreasing in the first direction when viewed in the direction in which the fixing member is inserted into the fixture.

3. The sprinkler head bracket according to claim 2, wherein the first direction is a direction perpendicular to the direction in which the fixing member is inserted into the fixture.

4. The sprinkler head bracket according to claim 1, wherein a sectional shape of at least a part of an inner side of the fixture gradually decreases in width in a second direction.

5. The sprinkler head bracket according to claim 4, wherein the second direction is a direction in which the fixing member is inserted into the fixture.

6. The sprinkler head bracket according to claim 1, wherein the fixing member comprises:
a head;
a screw thread portion connected to the head, the screw thread portion comprising a screw thread; and
a tapered portion connected to the screw thread portion, the tapered portion having a shape inclined such that a width of a section of the tapered portion is reduced.

7. The sprinkler head bracket according to claim 6, wherein the first through-hole comprises a screw thread corresponding to the screw thread of the fixing member.

8. The sprinkler head bracket according to claim 1, wherein
a sectional shape of at least a part of an inner side of the fixture gradually decreases in width in a second direction,
the fixing member comprises a tapered portion having a shape inclined such that a width of a section of the tapered portion is reduced, and
the tapered portion comes into contact with an inclined side of the fixture as the fixing member is inserted into the fixture, whereby the fixing member is inserted into the fixture while moving in the first direction.

9. The sprinkler head bracket according to claim 1, further comprising a hinge member configured to allow the first fastening member and the second fastening member to rotate relative to each other thereabout.

10. The sprinkler head bracket according to claim 1, further comprising a spring member configured to press the first fastening member and the second fastening member such that the first fastening member and the second fastening member are in a closed state.
